(19) United States
(12) Patent Application Publication
(10) Pub. No.: US 2023/0415974 A1
(43) Pub. Date: Dec. 28, 2023

(54) ASSEMBLY COMPRISING A CAPSULE INTENDED TO RECEIVE A SUBSTANCE FOR PREPARING A BEVERAGE, AND A FILM LID

(71) Applicant: BRAIN CORP SA, Leudelange (LU)

(72) Inventor: Olivier Brivois, Differdange (LU)

(21) Appl. No.: 18/039,468

(22) PCT Filed: Nov. 30, 2021
(86) PCT No.: PCT/EP2021/083645

§ 371 Date: May 30, 2023

(30) Foreign Application Priority Data
Nov. 30, 2020 (LU) LU102246

(51) Int. Cl. B65D 85/804; B65D 77/20; B65D 65/46; B32B 7/02; B32B 7/12; B32B 29/00; B32B 27/10; B32B 27/34

(52) U.S. Cl. CPC B65D 85/8043; B65D 77/2024; B65D 65/466; B32B 7/02; B32B 7/12; B32B 29/005; B32B 27/10; B32B 27/34; B65D 2565/387; B32B 2250/03; B32B 2307/718; B32B 2307/7244; B32B 2307/7246; B32B 2307/7163; B32B 2307/7376; B32B 2439/70

(57) ABSTRACT

An assembly including a capsule intended to receive a substance for preparing a beverage, and a film lid intended to cover the opening (5) of the capsule after it has been filled with the substance, the film lid having at least one external layer and one internal layer that are joined together, the layers being made of a fibrous material, each having an area density and an oxygen transmission rate, the area density of the external layer being lower than the area density of the internal layer, the oxygen transmission rate of the internal layer being lower than the oxygen transmission rate of the external layer.

The invention relates to an assembly comprising a capsule intended to receive a substance for preparing a beverage and a film lid for closing said capsule after loading said substance.

Capsules comprising a body which can be made of plastic or ductile material such as aluminium are known, said body having a side wall bordered on either side by a bottom and by a rim surrounding an opening of said body, the film lid being intended to be associated with said rim in order to cover the opening.

Thus, after loading the substance and before preparing the beverage, the film lid allows ensuring a sealed closure of the capsule, in particular by forming a barrier against oxygen and moisture, in order to be able to preserve the organoleptic characteristics of the substance.

Such capsules are in particular intended for preparing a hot beverage of the coffee, tea or infusion type. To do this, a capsule is installed in the housing of a machine provided for this purpose, where it is held by a piston during the passage of an extractor liquid, for example, hot water, through it and the substance it contains, after piercing the bottom thereof by the pins of said piston.

In particular, the flow of the beverage through the opening requires breaking the film lid which is carried out jointly by the pressure of the extractor liquid in the capsule and by pressing the film lid onto a grid of the machine by means of the piston.

The known embodiments do not allow obtaining a good compromise between the pressure to be exerted, which must not be too significant for the quality of the beverage, and the sealing of the film lid which must be sufficient, and this in particular in relation to a biodegradable and/or compostable film lid.

Indeed, a film lid which is too resistant requires a coarser grinding of the substance to increase the pressure, but leads to a beverage which is too watery, and a film lid which can be too easily torn does not provide the sufficient friction for the quality of the beverage extracted through said film lid, in particular by limiting the formation of foam for a coffee.

The invention aims at improving the prior art by proposing in particular a film lid which has good sealing properties, in particular against oxygen and moisture, while being able to be optimally broken relative to the quality of the prepared beverage, said film lid can also be advantageously biodegradable and/or compostable.

To this end, the invention proposes an assembly comprising a capsule intended to receive a substance for preparing a beverage, said capsule comprising a body having a side wall bordered on either side by a bottom and by a rim surrounding an opening of said body, said assembly comprising a film lid intended to be associated with the rim in order to cover the opening after loading the substance in the capsule, the film lid having at least one external layer intended to be disposed opposite to the opening and an internal layer intended to be disposed between the rim and the external layer, said layers being associated on each other, the layers being made of fibrous material, each having an area density and an oxygen transmission rate, the area density of the external layer being lower than the area density of the internal layer, the oxygen transmission rate of the internal layer being lower than the oxygen transmission rate of the external layer.

Other particularities and advantages of the invention will appear in the following description, made with reference to the appended figures, in which:

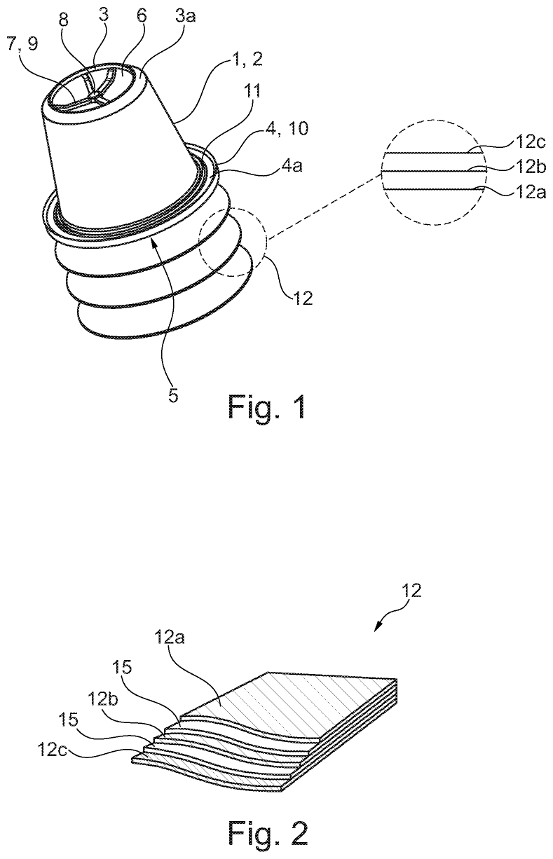

FIG. 1 represents, in exploded perspective, an assembly according to one embodiment of the invention;

FIG. 2 represents, in cutaway perspective, the structure of a film lid according to one embodiment of the invention;

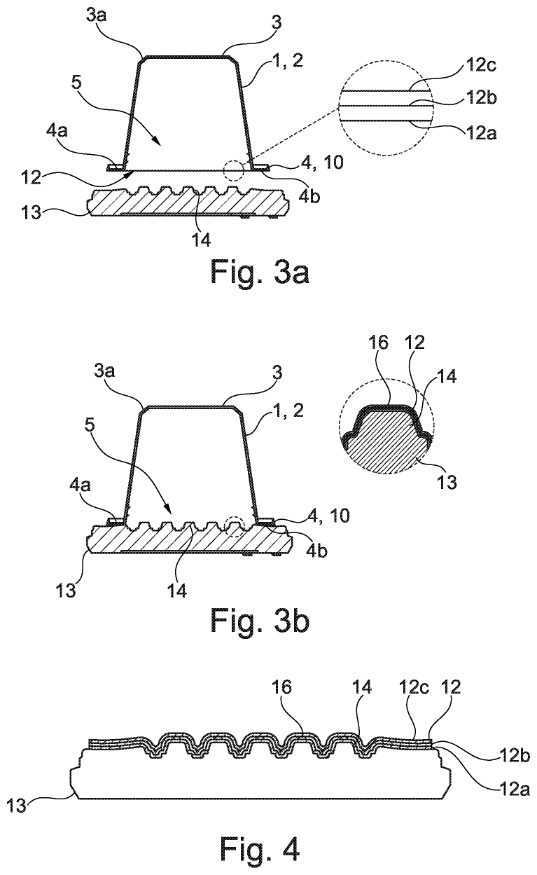

FIGS. 3a and 3b represent, during respectively a step of use in an extraction machine of an assembly according to the invention, the arrangement of said assembly relative to the grid of said machine;

FIG. 4 is a schematic sectional view of the pressing of a film lid according to the invention onto the grid of an extraction machine.

In relation to these figures, an assembly comprising a capsule 1 intended to receive a substance for preparing a beverage is described below.

The capsule 1 comprises a body which can be made of plastic or ductile material such as aluminium, said body having a side wall 2 bordered on either side by a bottom 3 and by a rim 4 surrounding an opening 5 of said body.

In relation to FIG. 1, the body of the capsule 1 has a geometry of revolution about a central axis forming a side wall 2 which is globally inscribed in a truncated cone with a straight generatrix between the bottom 3 and the upper rim 4.

In the represented embodiment, in relation to a capsule body 1 made by moulding a plastic material, the bottom 3 comprises a central opening 6 intended to be covered by a lower film lid to form the capsule, said film lid being intended to be pierced by the pins of the machine's piston when preparing a beverage. In particular, the bottom 3 comprises an upper crown 3a connected to the lower edge of the frusto-conical side wall 2.

The bottom 3 further comprises a crosspiece 7 which has a central hub 8 connected to the upper crown 3a by three branches 9. The branches 9 are curved upwards so as to enter into the internal volume of the capsule 1 by being separated from the bottom 3 by a sufficient distance to avoid any contact with the pins of the piston when using said capsule to prepare a beverage.

In relation to FIG. 1, the upper rim 4 has a lower wall 4a whose free outer edge is bordered by a stiffening crown 10, and whose inner portion, which is connected to the upper edge of the side wall 2, comprises sealing crowns 11 as described in the document EP-2 966 006.

The upper rim 4 has a smooth upper wall 4b on which a film lid 12 is intended to be associated. In particular, the opening 5 allows loading the substance in the storage volume defined in the body of the capsule 1, said opening being closed by the film lid 12 after said loading.

Thus, the film lid 12 allows ensuring a sealed closure of the capsule 1, in particular by forming a barrier against oxygen and moisture, in order to be able to preserve the organoleptic characteristics of the stored substance before the use thereof.

In particular, the capsule 1 is intended for preparing a hot beverage of the coffee, tea or infusion type. To do this, the capsule 1 can be disposed in the housing of a machine provided for this purpose, in order to be held therein by a piston provided with pins to pierce the bottom 3 of said capsule. Furthermore, the bottom 3 is crossed by at least one spindle to inject extractor liquid, in particular hot water, into the substance contained in the capsule 1.

When the capsule 1 is disposed in the housing of the machine, the peripheral edge of the piston (not represented) bears on the lower wall 4a of the upper rim 4 while limiting leaks during the injection of the extractor liquid into the capsule 1. In particular, especially for a body made of ductile material, the lower wall 4a can be equipped with a sealing ring, for example made of elastomeric material or fibrous material.

Thus, by the pressure of the extractor liquid in the capsule 1, the film lid 12 can be broken to allow the flow of the beverage through the opening 5, the machine comprising in particular a collector of said flow to distribute it in a container for the beverage.

Conventionally, the machine comprises a grid 13 which surmounts the collector, the piston being arranged to press the film lid 12 onto said grid during the extraction. Thus, by providing that the grid 13 has protruding pins 14 and that the piston exerts a sufficient pressing force, the film lid 12 can be weakened prior to the injection of the liquid in order to be able to reduce the pressure necessary for the breakage thereof.

The film lid 12 has at least one external layer 12a intended to be disposed opposite to the opening 5 and an internal layer 12b intended to be placed between the rim 4 and the external layer 12a, said layers being associated on each other.

Advantageously, the film lid 12 comprises a sealing layer 12c on the rim 4, said sealing layer being associated on the internal layer 12b opposite to the external layer 12a. The sealing layer 12c can be adapted to the heat and/or cold sealing.

In relation to FIG. 2, each of the layers 12a, 12b, 12c of the film lid 12 are associated by a film of adhesive 15. According to one embodiment, a biodegradable adhesive, for example based on corn starch, can be used in order to facilitate the elimination by composting of the waste generated by the capsule 1.

The internal 12b and external 12a layers are made of fibrous material, each having an area density and an oxygen transmission rate, the area density of the external layer 12a being lower than the area density of the internal layer 12b, the oxygen transmission rate of the internal layer 12b being lower than the oxygen transmission rate of the external layer 12a.

Thus, the film lid 12 allows combining an internal layer 12b having a high area density and sufficient oxygen tightness for the barrier function, with an external layer 12a of lower area density and without specific barrier function, in which the fragility of an internal layer 12b of limited thickness can be compensated by the thickness of the external layer 12a.

Moreover, the applicant noted that the bearing of this combination of layers 12a, 12b on the grid 13 of an extractor machine induced a significant deformation of the external layer 12a by pressing on the pins 14 of said grid, which causes a multitude of small break areas 16 by stretching in the internal layer 12b, said areas sufficiently weakening the film lid 12 to limit the dispensing pressure of the beverage and promote the friction of the extracted beverage therethrough (see FIGS. 3b and 4).

Advantageously, the thickness of the external layer 12a is greater than the thickness of the internal layer 12b. According to exemplary embodiments, the thickness of the external layer 12a is comprised between 60 and 100 μm, and the thickness of the internal layer 12b is comprised between 30 and 70 μm.

According to exemplary embodiments, an internal sealing layer 12b has an oxygen transmission rate of at most 5 cm³/m²·day·atm, and in particular less than 1 cm³/m²·day·atm, according to the ASTM D3985 standard, and an area density comprised between 40 and 90 g/m².

In addition, the internal layer 12b can have a water vapour transmission rate which is less than 100 g/m²·24 h, measured according to the ASTM E96 standard.

According to exemplary embodiments, the external layer 12a is porous while having an air permeability which is greater than 500 l/m²·s, according to the ISO 9237 standard. The area density of the external layer 12a can be comprised between 10 and 40 g/m², the area density of the film lid 12 possibly being comprised between 100 and 120 g/m².

According to one embodiment, at least one, and in particular both, of the internal layer 12b and the external layer 12a is made from cellulosic fibres, in particular of paper. In particular, the internal layer 12b can be based on microfibrillated cellulose (MFC) and/or the external layer 12a can be based on a filter-type paper.

Advantageously, the internal layer 12b may be in the form of a paper layer formed with microfibrillated cellulose so as to be highly fibrillated, by being in particular translucent, so as to be able to be particularly barrier to oxygen.

The microfibrillated cellulose consists of cellulose microfibrils that are individualised or in the form of aggregates. These microfibrils generally have a diameter of 2 to 20 nanometres, and a length in the range of a few micrometres. The microfibril aggregates are composed of several cellulose microfibrils agglomerated with each other.

The production of MFC is based on the release of the elements constituting the secondary wall of lignocellulosic fibres by mechanical means coupled to enzymatic or chemical pre-treatments. The used fibres can be unbleached or bleached chemical pulp, mechanical pulp produced from wood, recycled pulp . . . .

Moreover, the internal layer 12b, in particular based on MFC, may have been treated to improve its moisture resistance, for example by means of a moisture barrier coating.

According to one embodiment, a water vapour barrier lacquer is applied on the internal layer 12b to give it a water vapour transmission rate which is less than 50 g/m²·24 h, in particular less than 5 g/m²·24 h and more particularly less than 1 g/m²·24 h.

The invention allows considering a biodegradable and/or compostable film lid 12, in particular in combination with a sealing layer 12c based on polylactic acid (PLA) and/or cellulose and glue. Alternatively, the sealing layer 12c can be based on Polyhydroxyalkanoate (PHA) or based on polybutylene succinate (such as BioPBS).

Moreover, in order to facilitate the treatment of waste, the capsule 1 can also be biodegradable and/or compostable, in particular by having a body made from a compostable material according to the EN 13432 standard, as for example described in the document WO-2019/185637.

In particular, the materials constituting the capsule 1 and the film lid 12 can be chosen to allow both industrial and domestic composting, and can be biodegradable. Advantageously, the body of the capsule 1 is produced by injection of a plastic material based on polylactic acid (PLA) or Polyhydroxyalkanoate (PHA), insofar as these materials, in addition to being compostable and compatible with food substances, allow easily producing by injection capsules 1 with thin walls, and which do not deform under the effect of heat.

In relation to such a capsule 1, four exemplary embodiments of the film lid 12 are described below.

### EXAMPLE 1

External layer 12a: filter paper; area density 20-23 g/m²; thickness 65-85 μm; air permeability greater than 950 l/m²·s;
Internal layer 12b: MFC paper; area density 60-65 g/m²; thickness 50-60 μm; oxygen transmission rate less than 0.2 cm³/m²·day·atm; water vapour transmission rate 70-80 g/m²·24 h;
Sealing layer 12c: PLA; area density 15-25 g/m²; thickness 150-250 μm.

The film lid 12 according to this example has a weight in the range of 112 g and can be industrially compostable.

### EXAMPLE 2

External layer 12a: filter paper; area density 20-23 g/m²; thickness 65-85 μm; air permeability greater than 950 l/m²·s;
Internal layer 12b: MFC paper; area density 60-65 g/m²; thickness 50-60 μm; oxygen transmission rate less than 0.2 cm³/m²·day·atm; on which a water vapour barrier lacquer has been applied to give it a water vapour transmission rate of less than 5 g/m²·24 h;
Sealing layer 12c: PLA; area density 15-25 g/m²; thickness 150-250 μm.

The film lid 12 according to this example has a weight in the range of 112 g and can be industrially compostable.

### EXAMPLE 3

External layer 12a: filter paper; area density 25-g/m²; thickness 80-100 μm; air permeability greater than 950 l/m²·s;
Internal layer 12b: MFC paper; area density 60-65 g/m²; thickness 50-60 μm; oxygen transmission rate less than 0.2 cm³/m²·day·atm; water vapour transmission rate 70-g/m²·24 h;
Sealing layer 12c: PLA; area density 15-25 g/m²; thickness 150-250 μm.

The film lid 12 according to this example has a weight in the range of 116 g and can be industrially compostable.

### EXAMPLE 4

External layer 12a: filter paper; area density 20-23 g/m²; thickness 65-85 μm; air permeability greater than 950 l/m²·s;
Internal layer 12b: MFC paper; area density 60-65 g/m²; thickness 50-60 μm; oxygen transmission rate less than 0.2 cm³/m²·day·atm; water vapour transmission rate 70-g/m²·24 h;
Sealing layer 12c: filter paper; area density 10-g/m²; thickness 40-50 μm.

The film lid 12 according to this example has a weight in the range of 110 g and can be domestically compostable.

In the examples above, the sealing layer 12c can be replaced by a sealant lacquer applied on the internal layer 12c so as to form a two-layer film lid 12.

1. An assembly comprising a capsule intended to receive a substance for preparing a beverage, said capsule comprising a body having a side wall bordered on either side by a bottom and by a rim surrounding an opening of said body, said assembly comprising a film lid intended to be associated with the rim in order to cover the opening after loading the substance in the capsule, the film lid having at least one external layer intended to be disposed opposite to the opening and an internal layer intended to be disposed between the rim and the external layer, said layers being associated on each other, said assembly being characterised in that the layers are made of fibrous material, each having an area density and an oxygen transmission rate, the area density of the external layer being lower than the area density of the internal layer, the oxygen transmission rate of the internal layer being lower than the oxygen transmission rate of the external layer.

2. The assembly according to claim 1, the oxygen transmission rate of the internal layer being at most 5 cm³/m²·day·atm, according to the ASTM D3985 standard to form a sealing layer.

3. The assembly according to claim 1, the internal layer having a water vapour transmission rate which is less than 5 g/m²·24 h, measured according to the ASTM E96 standard.

4. The assembly according to claim 1, the external layer having an air permeability which is greater than 500 l/m²·s, according to the ISO 9237 standard to form a porous layer.

5. The assembly according to claim 1, the area density of the internal layer being between 40 and 90 g/m².

6. The assembly according to claim 1, the area density of the external layer is comprised being between 10 and 40 g/m².

7. The assembly according to claim 1, wherein the thickness of the external layer is greater than the thickness of the internal layer.

8. The assembly according to claim 1, wherein the thickness of the external layer is comprised between 60 and 100 μm.

9. The assembly according to claim 1, wherein the thickness of the internal layer is comprised between 30 and 70 μm.

10. The assembly according to claim 1, the film lid including a sealing layer on the rim, said sealing layer being associated on the internal layer opposite to the external layer.

11. The assembly according to claim 1, wherein at least one of the internal layer and the external layer is made from cellulosic fibres.

12. The assembly according to claim 11, wherein the external layer is based on a filter-type paper.

13. The assembly according to claim 11, wherein the internal layer is based on microfibrillated cellulose MFC.

14. The assembly according to claim 1, wherein the internal layer has been treated to improve its moisture resistance.

15. The assembly according to claim 1, at least one of the body of the capsule and the film lid is biodegradable and/or compostable.
